(19) United States
(12) Patent Application Publication
(10) Pub. No.: US 2006/0026530 A1
(43) Pub. Date: Feb. 2, 2006

(54) DMA overlay addressing methodology for optimizing power and improving memory bandwidth for display engines

(75) Inventors: Thomas J. Shepherd, McKinney, TX (US); Nishanth Rajan, Richardson, TX (US); Sang-Won Song, Plano, TX (US); Moslema Sharif, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/903,752

(22) Filed: Jul. 30, 2004

(51) Int. Cl. G06F 17/00

(52) U.S. Cl. 715/790

(57) ABSTRACT

A method, comprising determining parameters for a first window and a second window on a display screen, said first window superimposed in front of the second window. The method further comprises determining which areas of the second window are not superimposed by the first window and dividing the areas into multiple portions, each portion abutting a separate side of the first window. For each of the portions, the method comprises fetching pixel data from a memory using an addressing mode suitable for said portion and displaying said pixel data on the display screen.

### BACKGROUND

Many electronic devices (e.g., personal computers (“PC”), mobile phones, personal digital assistants) comprise graphical/video display systems that enable an end-user to simultaneously view multiple graphical/video images on a single display. Graphical/video display systems provide such multiple-image functionality using hardware overlay support, wherein multiple direct memory access (“DMA”) channels are used to fetch graphical pixel data from various memory locations. Referring to FIG. 1a, a PC 98 may display on a display panel 100 a still graphical image 102 obtained from, for example, a website. In “front” of (i.e., superimposed over) this graphical image 102, the PC 98 may play a video in a video window 104 using an appropriate media player, such as Microsofte Windows® Media Player or RealPlayer®. The orientation of the graphical image 102 and the video window 104 may be altered by an end-user using an input device, such as a keyboard 94 or a mouse 96.

In some instances, the video window 104 is displayed in front of the graphical image window 102 for a substantial period of time (e.g., a video window displaying a video clip or a lengthy film will be in front of other background images for most, if not all, of the duration of the video). The portion of the graphical image window 102 overlapped by the video window 104 is invisible to the end-user. Thus, it is a waste of memory bandwidth to fetch pixel data from memory that is used to create the portion of the background graphical images 102 that will not be shown to the end-user on the display 100. Furthermore, DMA channel clocks (not shown) are used to help retrieve these unnecessary pixel data from memory. Thus, these clocks are unnecessarily consuming power that could otherwise be conserved.

### BRIEF SUMMARY

The problems noted above are solved in large part by a method of retrieving from memory only the pixel data that will be displayed on a display. One exemplary embodiment may comprise determining parameters for a first window and a second window on a display screen, said first window superimposed in front of the second window. The method further comprises determining which areas of the second window are not superimposed by the first window and dividing the areas into multiple portions, each portion abutting a separate side of the first window. For each of the portions, the method comprises fetching pixel data from a memory using an addressing mode suitable for said portion and displaying said pixel data on the display screen.

### BRIEF DESCRIPTION OF THE DRAWINGS

For a detailed description of exemplary embodiments of the invention, reference will now be made to the accompanying drawings in which:

FIG. 1a shows a personal computer display panel displaying a video window in front of a graphical image window;

FIG. 1b shows an exemplary hardware overlay support system comprising multiple DMA channels;

FIG. 2a shows how pixel data memory is organized;

FIG. 2b shows an example of Post Increment Mode;

FIG. 2c shows an example of Single Indexing Mode;

FIG. 2d shows an example of Double Indexing Mode;

FIG. 3a shows a coordinate system in relation to the display of FIG. 1b;

FIG. 3b shows how an exemplary graphical portion of memory is addressed;

FIG. 3c shows the graphical portion if memory in context of Overlay Addressing Block Methodology, in accordance with embodiments of the invention;

FIG. 4 shows various display possibilities that may be handled by Overlay Addressing Block Methodology, in accordance with embodiments of the invention; and

FIG. 5 shows an exemplary finite state machine used to implement the Overlay Addressing Block Methodology, in accordance with a preferred embodiment of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The subject matter presented herein uses Overlay Addressing Block Methodology to preserve system bandwidth and power by retrieving only those pixels that will be displayed on a display panel. For purposes of clarity and ease of understanding, a description of hardware overlay support and three DMA addressing modes commonly used therein are presented prior to a description of the Overlay Addressing Block Methodology. These three DMA addressing modes are Post Increment Mode, Single Indexing Mode, and Double Indexing Mode.

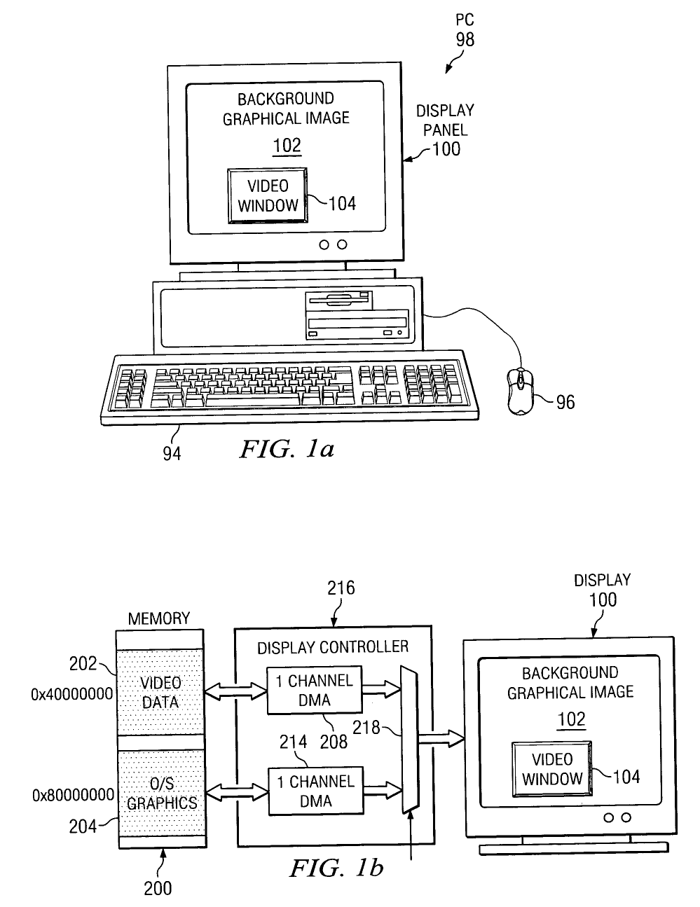

FIG. 1b shows a memory 200 comprising a video data portion 202 and a graphics data portion 204. The video data portion 202 contains pixel data used to render video images and the graphical data portion 204 contains pixel data used to render still, graphical images. The memory 200 is coupled to a display controller 216 comprising single DMA channels 208, 214 and a multiplexer 218. The DMA channel 208 transfers data between the video data memory portion 202 and the multiplexer 218. Similarly, the DMA channel 214 transfers data between the graphics data memory portion 204 and the multiplexer 218. The display controller 216 also is coupled to a display panel 100 that shows the video window 104 in front of the background image window 102. Pixel data used to form images shown in the background image window 102 are obtained from the graphics portion 204 (i.e., address 0x80000000) of the memory 200. These pixel data are transferred to the display 100 by way of the single DMA channel 214 and are displayed on the display 100 (as background image 102). Pixel data that form the video window 104 are obtained from the video data portion 202 (i.e., address 0x40000000) of the memory 200. Pixel data from the video data portion 202 are transferred to the display 206 by way of the single DMA channel 208 and are displayed on the display 206 (as video window 104).

The multiplexer 218 selects pixels from the DMA channels 208, 214 such that images are accurately displayed on the display 206. For example, because the video window 104 overlaps a portion of the background graphical image 102, the multiplexer 218 must ensure that pixels chosen to fill this portion of the display 100 are fetched from the video data portion 202 of the memory 200 instead of the graphics portion 204. Likewise, the multiplexer 218 must ensure that all other areas of the display 206 are filled with pixels from the graphics portion 204 instead of the video data portion 202.

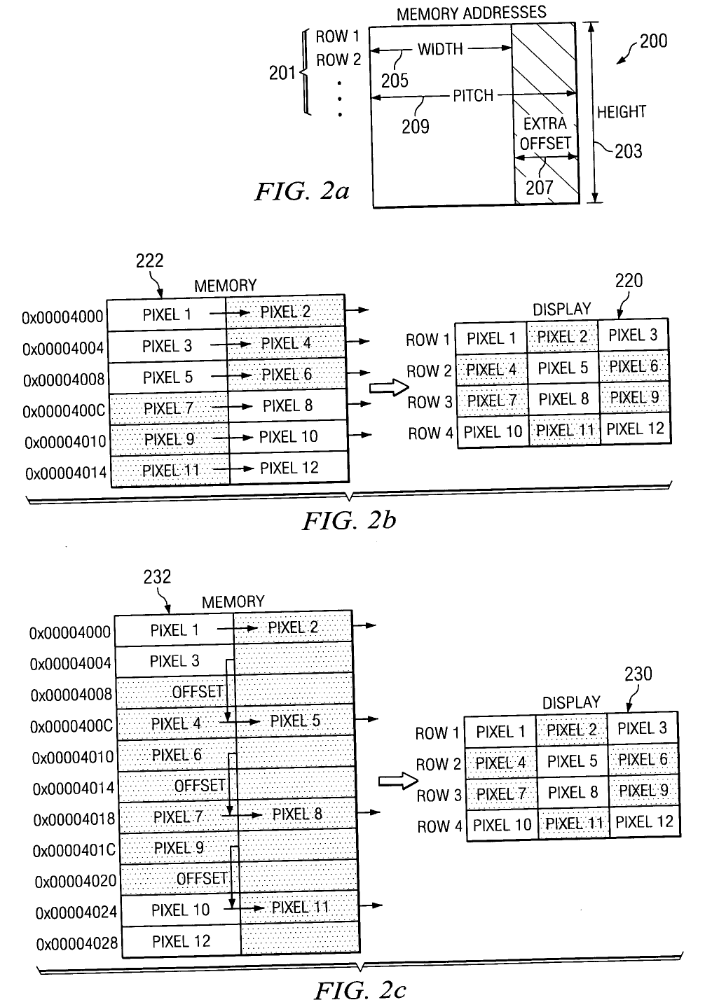

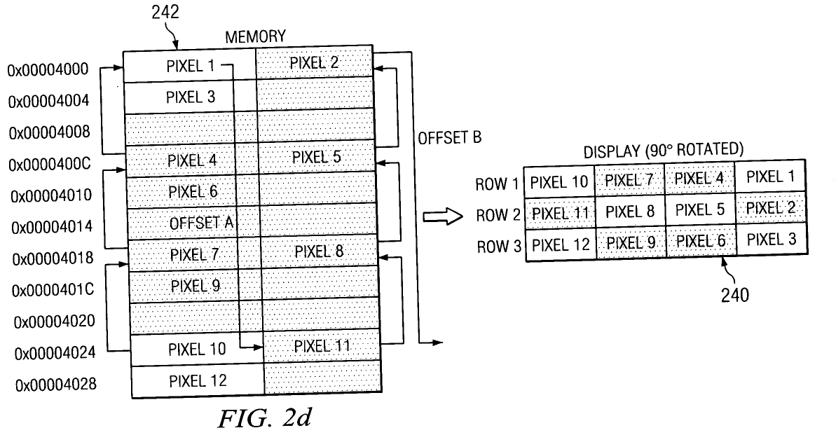

FIG. 2a illustrates how pixel data is stored in the memory 200. The memory 200 may have multiple rows 201, a height 203, a width 205, an extra offset 207, and a pitch 209, wherein the pitch 209 is the sum of the width 205 and the extra offset 207. Post Increment Mode (also known as Linear Addressing Mode) is a DMA addressing mode that is used when pixel data is stored consecutively in memory. Referring to FIG. 2b, for example, a display 220 is shown that has a width of 3 pixels and a height of 4 pixels. Each row in the display 220 has three pixels, and each pixel is labeled as Pixel 1, Pixel 2, . . . , Pixel 12. Because the pixels are arranged in the display 220 in this order, the pixel data are also fetched from memory 222 in this same order. As such, because the pixel data are already arranged in the memory 222 in the order in which the pixel data are to be fetched, Post Increment Mode is used here.

In this example, the size of a pixel is 2 bytes. The base address is 0x00004000, and is incremented by 0x00000002 to read each 2-byte pixel. Since each successive Pixel 1,2, . . . , 12 is stored consecutively in the memory 222, there is no need for an offset to jump to various memory addresses. However, in many cases, successive pixel data are not stored consecutively in memory. In such cases, an offset is necessary to jump to memory locations containing successive pixel data that are to be displayed on the display 100 (i.e., the extra offset 207 is present). Thus, the Single Indexing Mode or the Double Indexing Mode is used.

The Single Indexing Mode is used when the pixel data in one display row are stored consecutively, but an offset must be applied to display the next row of pixels. Referring to FIG. 2c, the display 230 is identical to the display 220 of FIG. 2b, but because the Pixels 1, 2, . . . , 12 are stored in the memory 232 by display row (i.e., Pixels 1, 2 and 3 are stored together; Pixels 4, 5 and 6 are stored together), an offset is applied to retrieve each successive row of pixels. Thus, the base starting address in the memory 232 is 0x00004000, and the address is incremented by 0x00000002 (2-byte pixels) until the end of Row 1 is reached (Pixel 3). Then, to begin filling Row 2 of the display 230, an offset of 0x00000006 is applied, so that the next memory address read is 0x0000400C, which contains Pixel 4. This algorithm is repeated until Rows 1-4 have been read and displayed on the display 230. However, in some instances, Single Indexing Mode is insufficient. For example, in cases where an image on the display 230 has been rotated, the pixels are no longer retrieved from the memory 232 as shown in FIG. 2c. In such cases, Double Indexing Mode is used.

In Double Indexing Mode, the offset used in single indexing mode is combined with an additional offset that is applied between adjacent pixels. For this reason, Double Indexing Mode is the most versatile and often-used of the three addressing modes. Specifically, FIG. 2d shows a display 240 that is nearly identical to the display 230 of FIG. 2c, except the display 240 has been rotated clockwise by 90 degrees. Thus, instead of having four rows of three columns each as in the display 230, the display 240 has three rows of four columns each. For this reason, pixel data are no longer retrieved from memory in the following consecutive order, as in the display 230: Pixel 1, Pixel 2, . . . , Pixel 12. Instead, pixels are retrieved from the memory 242 in the following order: Pixel 10, Pixel 7, Pixel 4, Pixel 1, Pixel 11, Pixel 8, Pixel 5, Pixel 2, Pixel 12, Pixel 9, Pixel 6, Pixel 3, since this is the order in which the pixels are displayed on the display 240. Referring to Row 1, because data for Pixel 10 is located at memory address 0x00004024 and data for the subsequent Pixel 7 is located at address 0x00004018, an offset A must be applied after reading Pixel 10 from the memory 242. Similarly, because pixel 1 is located at memory address 0x00004000 and the subsequent pixel 11 is located at memory address 0x00004026, an offset B is applied after reading pixel 1 from the memory 242. Thus, offset A is the offset used to retrieve pixels in the same row, and offset B is used to begin retrieving pixels in a succeeding row. As such, the display 240 is rendered by reading data for Pixel 10, applying an offset A, reading data for Pixel 7, applying an offset A, reading data for Pixel 4, applying an offset A, reading data for Pixel 1, applying an offset B, reading data for Pixel 11, applying an offset A, and so forth. Pixel data are read in this fashion until the display 240 has received the pixel data necessary to display Pixels 1-12.

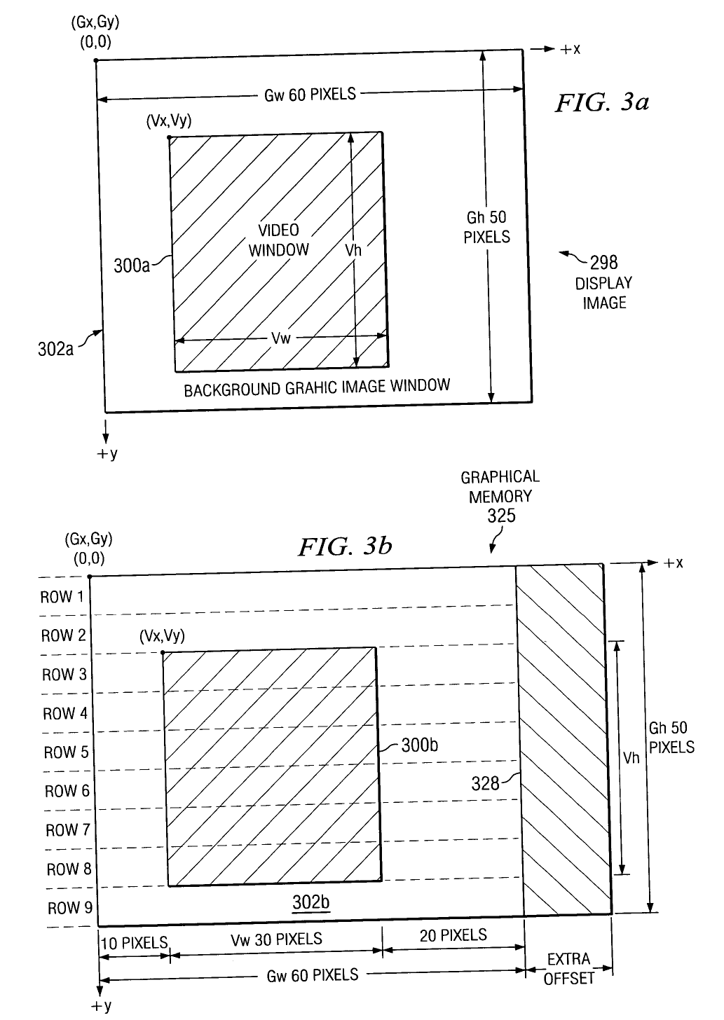

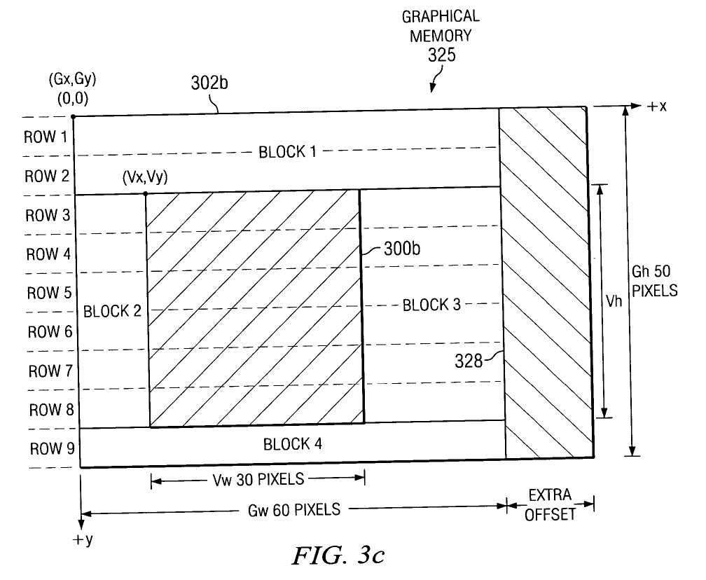

As previously explained, in order to improve system bandwidth and conserve power, only the pixel data that will actually be displayed on a display screen should be fetched from memory. FIG. 3a shows an exemplary display image 298 that comprises a video window 300a overlapping a background graphic window 302a. In this example, the background and graphic window 302a has a width G_{w} of 60 pixels and a height Gₕ of 50 pixels. The video window 300a has a width V_{w} of 30 pixels. The x-axis and the y-axis are oriented as shown. The upper-left x coordinate of the graphic window 302 is labeled Gₓ and the upper-left y coordinate of the graphic window 302 is labeled G_{y}. Likewise, the upper-left y coordinate of the video window 300 is labeled Vₓ and the upper-left y coordinate of the video window 300 is labeled V_{y}. The coordinate (Gₓ, G_{y}) is (0,0). The graphic window 302a is filled with pixel data retrieved from a graphical memory 325 as shown in FIG. 3b. The parameter values of Gₓ, G_{y}, Gₕ, G_{w}, Vₓ, V_{y}, Vₕ and V_{w} are continuously monitored by operating system (“OS”) software. If an end-user uses some computer input device (e.g., the mouse 96 or the keyboard 94) to reposition the video window 300a, for example, the OS software recognizes the end-user's actions and re-determines some or all of the parameter values of the video window 300a and the graphic window 302a.

FIG. 3b illustrates how the graphic memory 325 is organized, in context of the display image 298 of FIG. 3a. Pixel data that will be used to display the graphic window 302a of FIG. 3a are fetched from this graphical memory 325. The shaded portion 300b of the graphic memory 325 represents the portion of the graphic window 302a that will not be displayed (i.e., because the video window 300 is in front of this area). Thus, pixel data in the shaded portion 300b are not retrieved. Conversely, pixel data in the non-shaded portion 302b are retrieved for display. For example, because the graphic window 302a width G_{w} is 60 pixels, 60 pixel data are fetched from Row 1 and Row 2 of the memory 325. Because the shaded portion 300b occupies portions of Rows 3-8, for those rows, only 10 pixel data are fetched from the left side of the shaded portion 300b and 20 pixel data from the right side of the shaded portion 300b. Finally, 60 pixel data would be retrieved from Row 9.

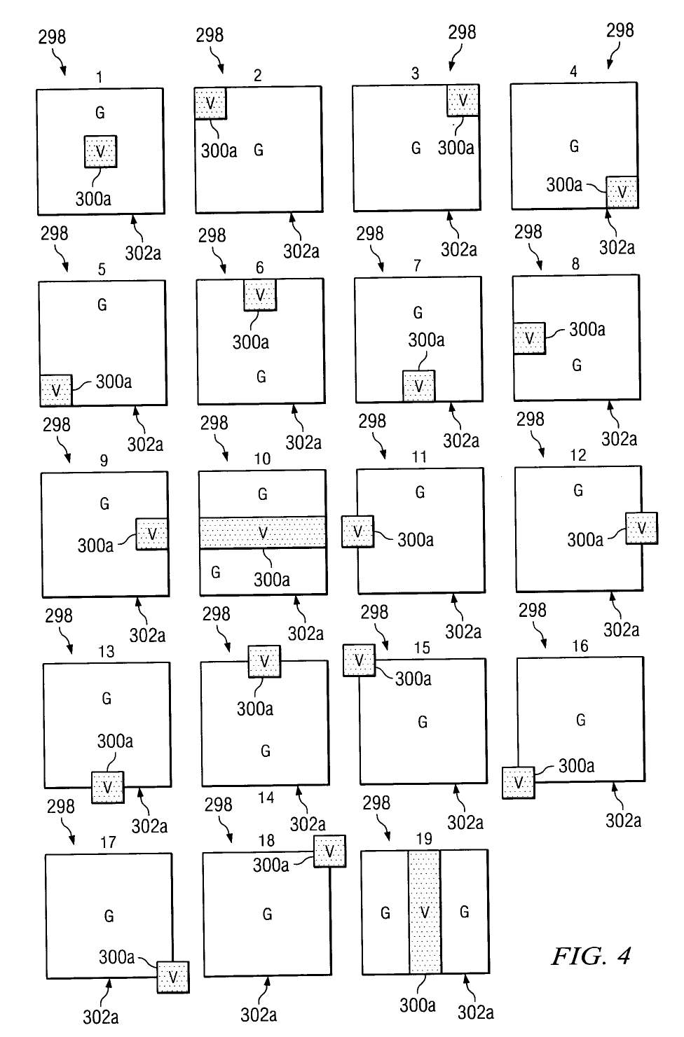

The location of the video window 300a (or, in context of the memory 325, the location of the shaded portion 300b) is variable and may be anywhere inside, partially outside, or sitting on the edge of the graphic window 302a. However, because the three addressing modes described above require regular, defined intervals between pixel data stored in memory, DMA channels cannot be programmed using the three addressing modes to accurately address the graphic memory 325 as shown in FIG. 3b. For this reason, a “block” methodology is used as shown in FIG. 3c. This block methodology divides the non-shaded portion 302b into four separate portions, or blocks. Depending on orientation, each block is addressed using the most suitable of the three addressing modes, although other addressing modes also may be used. These blocks are labeled Block 1, Block 2, Block 3 and Block 4. Block 1 is defined as portions of the graphic window 302a located above (i.e., at a lower y-coordinate than) the shaded portion 300b. Block 2 is defined as portions of the graphic window 302a located to the left of (i.e., at a lower x-coordinate than) the shaded portion 300b. Block 3 is defined as portions of the graphic window 302a located to the right of (i.e., at a greater x-coordinate than) the shaded portion 300b. Block 4 is defined as portions of the graphic window 302a located below (i.e., at a greater y-coordinate than) the shaded portion 300b. Because the video window 300a may be located at any position on the display image 298, the corresponding shaded portion 300b also may be located at any position on the graphic memory 325. Thus, in some cases, one or more of the four blocks may not exist. For example, FIG. 4 shows multiple possible orientations of the shaded portion 300b within the non-shaded portion 302b. If the shaded portion 300b is located at the top of the display image 298 as shown in FIG. 4f, then Block 1 does not exist. Similarly, if the shaded portion 300b is oriented as shown in FIG. 4j, then neither Block 2 nor Block 3 exists.

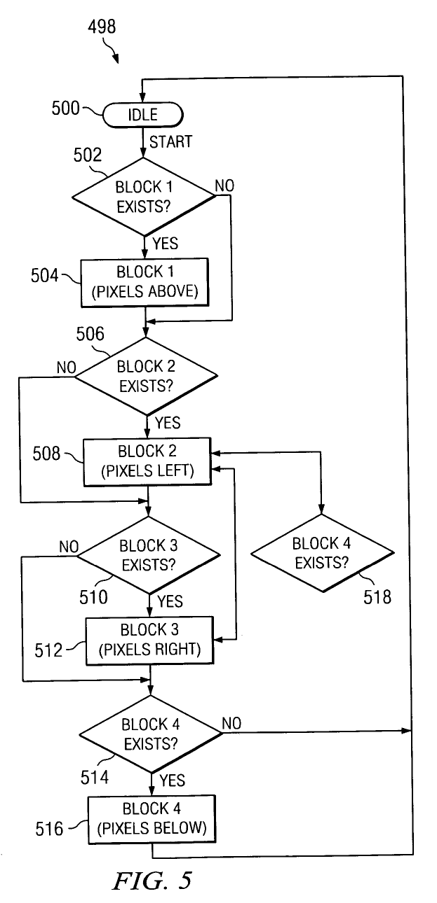

A finite state machine (“FSM”) is used to implement the block methodology. Referring to FIGS. 1b and 5, the steps of the FSM are performed by circuit logic (not shown) coupled to the hardware illustrated in FIG. 1b. Specifically, a FSM 498, illustrated in FIG. 5, will check for the presence of Blocks 1-4 on the display 298. For each block that is present, the FSM will cause the DMA channel 214 to fetch appropriate pixel data from the memory 200 using a suitable addressing mode. Referring to FIG. 5, the FSM 498 may begin in an idle state (step 500), wherein the FSM 498 is not actively retrieving pixel data from the memory 200 (i.e., during a display screen 100 frame shift or line shift). If no display screen 100 frame shift or line shift is in progress, then the FSM 498 begins by determining whether Block 1 exists (step 502) by comparing the values of V_{y} and G_{y} as shown in FIGS. 3a-3c. Block 1 exists if the value of V_{y} is greater than the value of G_{y}. If Block 1 does not exist, the FSM begins determining whether Block 2 exists (step 506). Otherwise, if Block 1 exists, the DMA channel 214 will use a double indexing addressing mode (or any suitable addressing mode) to fetch pixel data that corresponds to Block 1 (step 504). The amount of pixel data to be fetched is determined by calculating the size of Block 1. Specifically, the height and width of Block 1 are calculated as:
Block 1 height=V_{y}−G_{y} (1)
Block 1 width=G_{w} (2)
By determining the height and width of Block 1, the DMA channel 214 can retrieve pixel data from the memory 200 as described above in context of FIG. 2d. As previously explained, unless the image shown in Block 1 has been rotated, the offset A of Double Indexing Mode is set at zero, since no offset is necessary.

The FSM proceeds by determining whether Block 2 exists (step 506). Block 2 exists if the value of Vₓ is greater than the value of Gₓ and if the value of (G_{y}+Gₕ) is greater than the value of V_{y}. If Block 2 exists, then the height and width of Block 2 are calculated as follows:
Block 2 height=V_{y}−G_{y} (3)
Block 2 width=Vₓ−Gₓ (4)
Expression 3 determines the height of Block 2. However, because the video window 300 may not always be fully enclosed within the graphic window 302 (e.g., as in FIG. 4m), the height of Block 2 cannot always be determined using expression 3. Expression 3 may be used only when the video window 300 is fully enclosed within the graphic window 302 (i.e., when Block 4 exists). Thus, it is necessary to detect the existence of Block 4 (step 518) prior to calculating the height of Block 2. The existence of Block 4 may be determined using expression 9 below.

Referring to FIGS. 1b and 3c, the DMA channel 214 fetches pixel data for Blocks 2 and 3 in a manner different than that used for Block 1. More specifically, as described above, pixel data is fetched from the memory 200 by row. Thus, all pixel data representing Row 1 is fetched, followed by pixel data for Row 2, and so forth. However, because there exists the shaded portion 300b between Blocks 2 and 3, the DMA channel 214 must obtain pixel data for Blocks 2 and 3 in an alternating (or “ping-pong”) fashion. For example, in reading pixel data for Row 3, the DMA channel 214 reads a number of pixel data corresponding to the width of Block 2 (i.e., as calculated in expression 4 above). After reading these data, the DMA channel 214 “skips” memory locations corresponding to Row 3 of the shaded portion 300b and begins reading for Block 3 a number of pixel data corresponding to the width of Block 3 (if Block 3 exists). Because double indexing mode is used, the DMA channel 214 can skip memory addresses corresponding to the shaded portion 300b by setting offset B according to the width of the shaded portion 300b. Accordingly, for a given Row 3-8, once the DMA channel 214 finishes reading memory for Block 2, the offset B will skip memory addresses corresponding to the shaded portion (i.e., video window) 300b and resume reading memory for Block 3 in that same row, if Block 3 exists.

The existence of Block 3 is determined in step 510 of the FSM. More particularly, Block 3 exists if both of the following two expressions are true:
((Gₓ+G_{w})>(Vₓ+V_{w})) (5)
((G_{y}+Gₕ)>V_{y}) (6)

If Block 3 exists, the FSM calculates the height of width of Block 3 as follows:
Block 3 width=(G_{w}+Gₓ−(Vₓ+V_{w})) (7)
Block 3 height=V_{y}−G_{y} (8)
The DMA channel 214 uses double indexing mode to retrieve pixel data from the memory 200 for Block 3. The DMA channel 214 uses offset A to read consecutive pixel data in the same row. The DMA channel 214 uses offset B for pitch adjustment by skipping the extra offset 328 and resumes reading data on the next row. The DMA channel 214 continues reading Blocks 2 and 3 in this alternating fashion until Blocks 2 and 3 have been fully read.

After reading Block 3, the FSM may re-confirm that Block 4 is present (step 514); however, this may be unnecessary, since the presence of Block 4 was previously verified in step 518. Block 4 is present if the following expression is true:
(G_{y}+Gₕ)>(V_{y}+Vₕ) (9)
If Block 4 is present, then the FSM will calculate the width and height of Block 4 as follows:
Block 4 width=G_{w} (10)
Block 4 height=Gₕ−Vₕ−V_{y}−G_{y} (11)

The DMA channel 214 then uses double indexing mode (or any other appropriate addressing mode) and the Block 4 height and width calculations to fetch pixel data for Block 4. In reading Block 4 pixel data, offset B is used to skip over the extra offset 328. After pixel data for Block 4 have been read from the memory 200 and displayed on the display 100, the FSM 498 process is complete.

Because pixel data for the memory locations found within the shaded portion 300b of FIG. 3c is not read, memory bandwidth is conserved and system performance is enhanced over that of existing technology. Furthermore, because these memory locations are not read, the entire display rendering process is completed at a faster rate, and time is conserved as well. Further still, because time is conserved, system clocks that control the DMA channel 214 may be temporarily shut off until the clocks are needed again, thus conserving power.

The scope of disclosure is not limited to the FSM 498 shown in FIG. 5. Any of a variety of FSMs may be used to implement the Overlay Addressing Block Methodology described above. Furthermore, although the Overlay Addressing Block Methodology is described in context of a video window overlapping a graphical image window, the scope of disclosure is not limited to this combination. Other pertinent overlapping combinations comprise a graphical image in front of another graphical image, a graphical image in front of a video window, a video window in front of a video window, and so forth. Some systems may even display three, four or more images at one time.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
determining parameters for a first window and a second window on a display screen, said first window superimposed in front of the second window;
determining which areas of the second window are not superimposed by the first window;
dividing the areas into multiple portions, each portion abutting a separate side of the first window;
for each of said portions, fetching pixel data from a memory using an addressing mode suitable for said portion; and
displaying said pixel data on the display screen.

2. The method of claim 1, wherein fetching pixel data from the memory using an addressing mode suitable for said portion comprises fetching pixel data from the memory using an addressing mode selected from a group consisting of linear addressing mode, single indexing mode and double indexing mode.

3. The method of claim 2, wherein using an addressing mode comprises using an offset to skip memory addresses.

4. The method of claim 3, wherein using an offset to skip memory addresses comprises using an offset to skip memory addresses corresponding to a section of the second window superimposed by the first window.

5. The method of claim 1, wherein fetching pixel data from a memory using an addressing mode suitable for said portion comprises calculating the height of said portion.

6. The method of claim 1, wherein fetching pixel data from a memory using an addressing mode suitable for said portion comprises calculating the width of said portion.

7. The method of claim 1, further comprising shutting off a direct memory access channel clock to conserve power.

8. The method of claim 1, wherein determining parameters for a first window and a second window comprises determining parameters for a graphical image window and a video window.

9. The method of claim 1, wherein determining parameters for a first window and a second window comprises determining parameters for two graphical image windows.

10. The method of claim 1, wherein the steps of determining, determining, dividing, fetching and displaying comprise using a finite state machine.

11. The method of claim 1, wherein determining parameters comprises monitoring end-user input for changes in first window position and second window position.

12. A system, comprising:
a display comprising a first window superimposed on a second window;
a display controller coupled to said display, the display controller comprising multiple direct memory access (“DMA”) channels; and
a memory coupled to said display controller and storing operating system (“OS”) software, said software adapted to detect areas of the second window not superimposed by the first window;
wherein the areas are divided into multiple portions, each portion abutting a separate side of the first window;
wherein the DMA channels use an addressing mode appropriate for each of said portions to fetch from the memory pixel data corresponding to said portion;
wherein, for each of said portions, the display displays the pixel data.

13. The system of claim 12, wherein at least some of the areas are rectangular in shape.

14. The system of claim 12, wherein the software monitors end-user input for changes in first window and second window position.

15. The system of claim 14, wherein the software re-calculates window parameters based on said changes.

16. The system of claim 12, wherein the display further comprises at least one additional window superimposed on the second window, and wherein the software is adapted to detect areas of the second window not superimposed by the at least one additional window.

17. The system of claim 12, wherein the DMA channels use an addressing mode selected from a group consisting of linear addressing mode, single indexing mode and double indexing mode.

18. The system of claim 17, wherein the DMA channels use an offset to skip memory addresses.

19. The system of claim 12, wherein the software calculates height and width parameters of the windows.

20. The system of claim 12, wherein the software calculates height and width parameters of the portions.

21. The system of claim 12, wherein the DMA channels comprise an internal clock that is shut off to conserve power.

22. The system of claim 12, wherein at least one of the windows is a graphical image window or a video window.

23. A computer system, comprising:
a means for displaying comprising a first window superimposed on a second window;
a means for controlling coupled to the means for displaying; and
a means for storing coupled to the means for controlling, said means of storing comprising software, said software adapted to detect areas of the second window not superimposed by the first window;
wherein the areas of the second window are divided into multiple portions;
wherein the means for controlling comprises multiple means for accessing the means for storing;
wherein the means for accessing use an addressing mode appropriate for each of said portions to fetch from the means for storing pixel data corresponding to said portion;
wherein, for each of said portions, the means for displaying displays the pixel data.

24. The system of claim 23, wherein the means for accessing use an addressing mode selected from a group consisting of linear addressing mode, single indexing mode and double indexing mode.

25. The system of claim 23, wherein the means for accessing use an offset to skip memory addresses.

26. The system of claim 23, wherein the software calculates height and width parameters of the windows.
